(19) United States
(12) Patent Application Publication
(10) Pub. No.: US 2012/0259960 A1
(43) Pub. Date: Oct. 11, 2012

(54) Dynamic Self-Configuration of Heterogenous Monitoring Agent Networks

(75) Inventors: Abhijit Sharma, Pune (IN); Geert De Peuter, Turnhout (BE)

(73) Assignee: BMC SOFTWARE, INC., Houston, TX (US)

(21) Appl. No.: 13/082,233

(22) Filed: Apr. 7, 2011

(51) Int. Cl. G06F 15/177

(52) U.S. Cl. 709/221

(57) ABSTRACT

A centralized, policy-driven approach allows dynamic self-configuration and self-deployment of large scale, complex, heterogeneous monitoring agent networks. Such an approach resolves the scalability and manageability issues of manually configured conventional agents. Embodiments of the agents can be self-configuring using a dynamic, adaptive technique. An administrator can group hosts on which agents into groups that have similarly configured agents.

### BACKGROUND

This disclosure relates generally to the field of computer software. More particularly, but not by way of limitation, it relates to a policy-driven technique for dynamically self-configuring and deploying large scale, complex, heterogeneous monitoring agent networks.

Monitoring agents are in widespread use to monitor infrastructure, software, packaged applications etc across the enterprise. Many enterprises have very large scale, complex, heterogeneous networks of agents, deploying thousand of agents to monitor their software, applications, infrastructure etc. Typical monitoring agents are not plug-n-play products and in such large-scale deployments the configuration, deployment, and manageability of the agent itself becomes very difficult.

Each agent may have a large set of configuration parameters, flags, thresholds, alarm ranges etc defined in its configuration to help control its monitoring functionality. The contents of this set of configuration parameters varies greatly based on the components to be monitored, including parameters that vary depending on the monitored domain and software, and may include monitored application specific modules, e.g. specific monitoring functionality for Oracle, Windows NT, etc. In a complex, large scale, heterogeneous environment, in which a wide variety of software applications are being monitored, maintaining these configuration parameters on a per agent basis quickly becomes a very difficult, if not impossible, task.

There are several drawbacks that make this approach untenable at the scale, complexity, and heterogeneity at which customers are using monitoring agents: (a) configuration is based on how the monitoring is to be accomplished, not what monitoring is desired; (b) there is no sharing and reuse of agent configuration; (c) configuration changes are not propagated to distributed monitoring agents; (d) per agent configuration process is manual, thus error-prone, and requires significant domain knowledge and expertise, with the person configuring the agent required to know what software is installed on a host and hence what configuration is required for the agent; (e) there is no scalability to the configuration process, because there is no way to use policies or rules to control configuration of the agents or to group configuration properties into meaningful sets or views, so that for example, a DB administrator cannot categorize groups of servers running a common database engine as a group and associate that group with a set of configuration properties, or managed the group and are thus more scalable; (f) agent configuration is not dynamic, but must be manually configured, so that if new software is deployed on a host monitored by a agent, the new software does not automatically start getting monitored, and if software is removed from a host, the relevant configuration does not get removed from the monitoring agent.

### BRIEF DESCRIPTION OF THE DRAWINGS

FIG. 1 is a block diagram illustrating an overview of one embodiment employing dynamic self-configuration and self-deployment of agents.

FIG. 2 is a flowchart illustrating a technique for employing dynamic self-configuration and self-deployment of agents according to one embodiment.

FIG. 3 is a block diagram illustrating an example of hierarchical grouping of hosts and host groups according to one embodiment.

FIG. 4 is a block diagram illustrating a technique for a establishing a host group-host hierarchy according to one embodiment.

FIG. 5 is a block diagram of a system employing a policy engine according to one embodiment.

FIG. 6 is a flowchart illustrating the operation of a policy engine according to one embodiment.

FIG. 7 is a block diagram illustrating an example computer for use in employing dynamic self-configuration and self-deployment of agents according to one embodiment.

FIG. 8 is a block diagram illustrating an IT infrastructure that may include elements that may be monitored by agents that incorporate a dynamic adaptive configuration technique.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

A centralized, policy-driven approach allows dynamic self-configuration and self-deployment of large scale, complex, heterogeneous monitoring agent networks. Such an approach resolves the scalability and manageability issues of manually configured conventional agents. Embodiments of the agents can be self-configuring using a dynamic, adaptive technique. An administrator can group hosts on which agents into groups that have similarly configured agents.

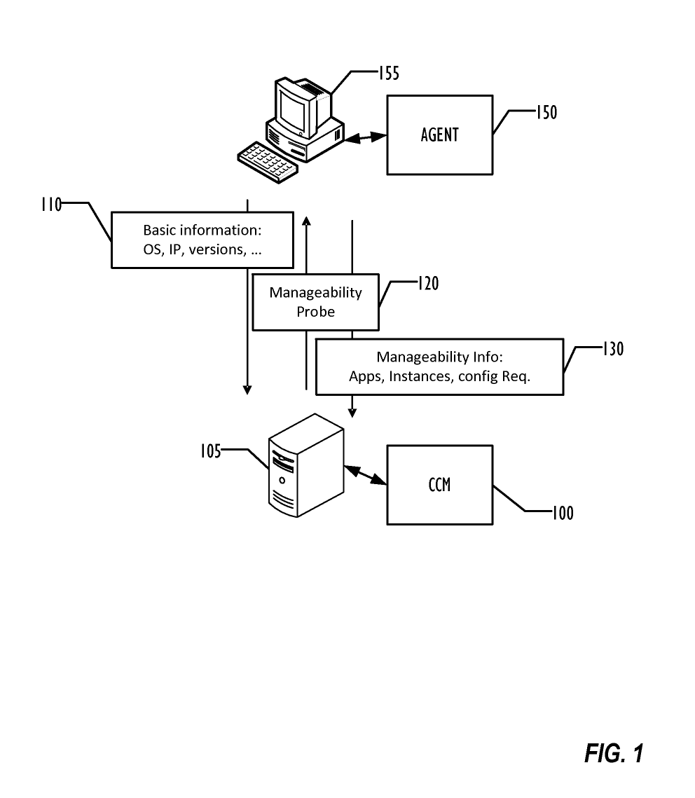

FIG. 1 is a block diagram illustrating an overview of one embodiment employing dynamic self-configuration and self-deployment of agents.

Initially when a bare bones agent 150 is installed on the host to be monitored 155, the agent 150 is a generic agent, initially configured with sufficient information to allow the agent 150 to contact a central configuration manager (CCM) 100 running on server 105. The contact information typically includes credentials for and a location of the CCM 100. In one embodiment, the contact information may include a port number or other information useful for making a connection with the CCM 100. Upon startup, the agent 150 may report the characteristics of the host/server characteristics back to the CCM 100 as a first collection of information 110. This first collection may include information such as the operating system (OS) running on the host 155, the IP address of the host 155,a version of the agent 150, and an identity of the host 155, all of which is reported to the CCM 100.

In one embodiment, the CCM 100 comprises all possible components that an enterprise has purchased rights to use and could potentially manage. In an alternate embodiment, the CCM 100 comprises all components that are available from a vendor of the CCM 100, even if the enterprise configuring the CCM 100 has not purchased rights to use some of those components.

The CCM 100 then pushes a manageability probe 120 to the agent 150. The probe 120 executes under the control of the agent 150, and discovers all manageable components that are configured on the host 155. After running the probe 120, the agent 150 reports the information about the platform on which the agent 150 is running and a basic inventory 130 of the manageable components associated with the host 155. Any desired format for the basic inventory 130 may be used. Preferably, the format of the basic inventory 130 is designed for easy parsing by the CCM 100. In one embodiment, the basic inventory 130 may include information that the host 155 is a Windows server, and that the probe 120 detected manageability of “Services,” “Processes,” and detected a specific instance of an Oracle database software.

The CCM 100 on receiving the basic inventory 130 analyzes it by using the context data, evaluating applicable policies, host group membership information and decides which management modules need to be enabled on the agent 150, their dependencies and their respective configuration, e.g., setting alarm thresholds, Simple Network Management Protocol (SNMP) settings, etc.

In one embodiment, the determination of manageability information and the enablement of management modules may be an iterative process. A management module when enabled may discover some additional information that is reported to the CCM 100. The CCM 100 may respond by analyzing and subsequently making changes to the configuration of the agent 150, including enabling additional management modules and updating the configuration of existing management modules of the agent 150. In a further embodiment, the iterative process may also involve intervention on the part of an administrative user to override the automatic selection of configuration information and enablement of management modules of the agent 150.

In one embodiment, a CCM 100 administrator may use a user interface for the CCM 100 to select which applications that have been discovered by the manageability probe should be monitored. The CCM 100 may include a configuration store, typically a database, in which the management modules may be loaded and stored for deployment with an agent 150.

Preferably, configuration is not a one-time activity by the CCM 100, but is a dynamic, adaptive, self-configuration cycle that the CCM 100 performs continuously, receiving events from the agent 150, analyzing the manageability data 130, and responding with changes to the configuration of the agent 150. For example, if new software is deployed on the host 155 monitored by agent 100, the management probe 120 on the agent 150 may discover the new software and report it to the CCM 100. The CCM 100 may then analyze the manageability information 130 and send the agent 150 appropriate configuration data to configure the agent 150 for enabling monitoring of that software. This dynamic update technique may be performed automatically without the need for any manual configuration by an administrative user. Similarly, if software is uninstalled from the host 155, the relevant configuration may be automatically removed from the configuration of the agent 150.

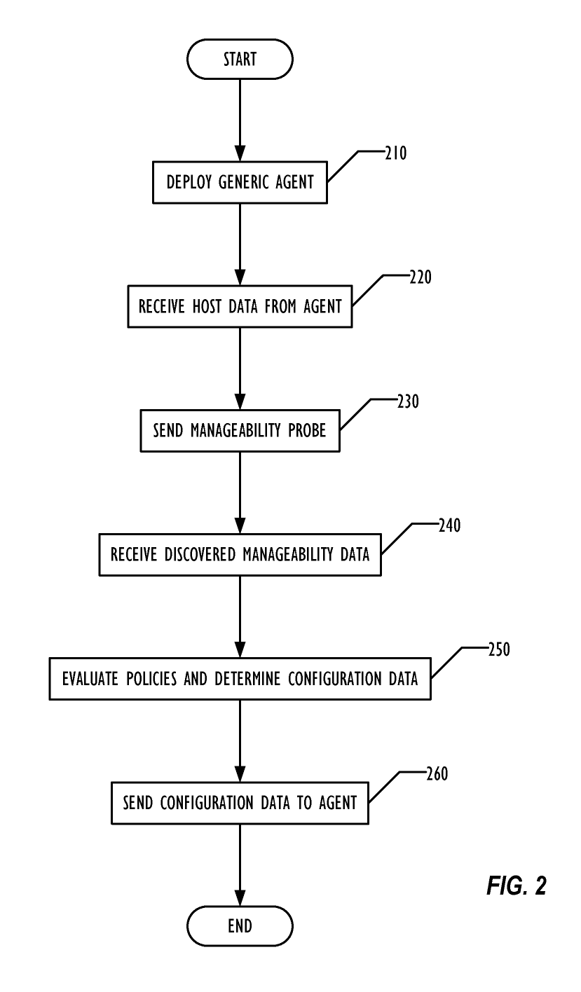

FIG. 2 is a flowchart illustrating the technique described above. In block 210, the CCM 100 deploys a generic agent 150, transmitting the agent 150 to a host 155. In block 220, the CCM 100 receives the basic inventory information 130 from the agent 150. In block 230, the CCM 100 sends a manageability probe 120 to the agent 150, which executes the manageability probe 120, to discover assets that may be managed on the host 155. In block 240, the CCM 100 receives information about the discovered manageable assets from the manageability probe 120. In block 250, the CCM 100 uses a policy engine (described below) to evaluate one or more policies that may determine configuration data that is to be supplied to the agent 150. In block 260, the CCM sends the policy-engine determined customized configuration data to the agent 150 for execution by the agent 150. The configuration data may be any form of configuration data that may be used by the agent 150, and may include simple variable settings as well as executable management modules that may be pushed to the agent 150 for execution. The agent 150 may then begin its task of monitoring the applications, etc. on the host 155.

As indicated above, blocks 240 through 260 may be iteratively performed, as the agent discovers additional manageability data, such as when a new software is installed on the host 155. This may include removal of configuration information, such as when an application is removed from the host 155.

As a result, the generic agents 150 may be automatically configured heterogeneously, with each agent 150 configured to monitor its corresponding host 155 based on what is discovered about the host 155.

In one embodiment, hosts 155 on which agents 150 execute may be organized into one or more host groups. Grouping improves scalability and other advantages.

From an administration perspective, grouping provides a convenient and scalable way to define various configuration views on the environment. For example, in one embodiment, a database administrator (DBA) is responsible for managing multiple databases, and may be given responsibility for dynamically related configuration parameters in the agent 150 by a policy. The DBA may decide to split their multiple databases (and thus their hosts 155) into groups corresponding to how the DBA differentiates between the groups in terms of configuration, such as defining Small, Medium and Large groups.

In one embodiment, groups and hosts may have associated metadata properties that can be used to dynamically bind and evaluate policies and thus configuration parameters at runtime. This runtime-determined configuration lends flexibility and dynamism to the configuration process.

Grouping allows administrators to deal with groups of hosts and the relationships between those hosts, instead of the individual hosts, which may reduce the number of distinct entities that have to be separately configured. Grouping provides a much more scalable and maintainable system than handling configuration on an individual basis for thousands of hosts.

In one embodiment, group membership of hosts and host groups may be dynamic based on some properties of the host or of the host group.

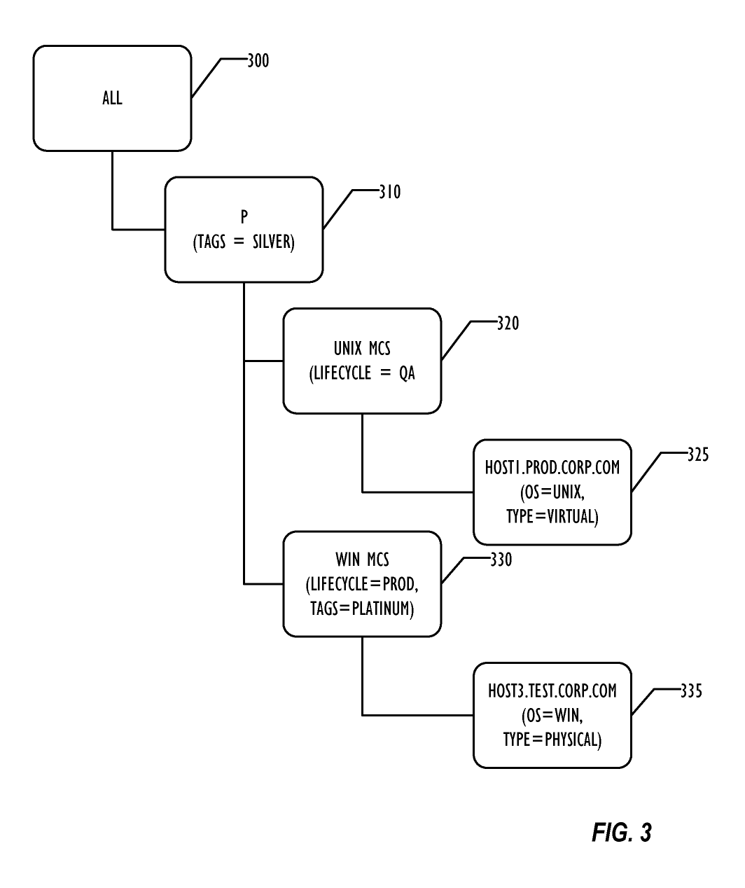

In one embodiment, relationships may be defined between groups, such as defining a hierarchical relation between groups, which can affect the order and priority of evaluation of dynamically associated policies. FIG. 3 is a block diagram illustrating an example of hierarchical grouping of hosts and host groups. FIG. 3 also illustrates some associated metadata properties (in this example, OS, host type, lifecycle, and host group tags) of hosts and host groups that can be used when evaluating policies.

In this example hierarchy, group 300 is a top-level group to which both hosts 325 and 335 belong. A group P (310) may be defined to include all hosts at a particular location or site. As illustrated in FIG. 3, group 310 not only is limited to hosts at site P, group 310 is to hosts having a tag of “silver.” Tags may be used to group hosts based on characteristics not directly tied to a specific type of hardware or software, but may be used to group hosts based on arbitrary characteristics. In one example, the tags may be defined to group hosts based on a service contract level, such as “Silver service,” “Gold service,” and “Platinum service.” The CCM may use such a tag to configure agents to provide different levels of monitoring based on service contracts, without having to configure each agent separately.

Two subgroups of group 310 are illustrated in FIG. 3. UNIX subgroup 320 is defined for hosts running a UNIX® OS, and in this example, limited to hosts at a particular stage in a development lifecycle, such as a quality assurance (QA) stage. (UNIX is a registered trademark of X/Open Company, Ltd.) Subgroup 330 is defined for hosts running a WINDOWS® OS. (WINDOWS is a registered trademark of Microsoft Corporation.)

Two hosts are illustrated in FIG. 3. Host 325 is identified with a hostname of host1.test.corp.com, and is indicated as running the UNIX OS, and being of type Virtual, which in this example indicates that the host 325 is a virtualized host. Although not indicated directly in FIG. 3, host 325 is in the QA lifecycle stage, and is managed under a Silver service level contract. Therefore, host 325 belongs to group 300, and subgroups 310 and 320. In contrast, host 335 is indicated as running a WINDOWS OS, and being a physical host, has a hostname of host3.test.corp.com. Host 335 is managed under a Platinum level service contract, and has a hostname of host1.prod.corp.com. Therefore, host 335 belongs to groups 300, 310, and 330.

In addition to using groups of hosts to provide a dynamic approach to self configuration and driving configuration, in one embodiment, a policy driven approach to driving large scale system self configuration provides even greater scalability. Policies may be used to compute the set of applicable agent configuration properties for a host.

In one embodiment, a policy contains one or more rules that follow the condition-action pattern, where a Boolean rule condition is evaluated and if it is true, the action part of the policy is executed. In such an embodiment, the action part of the policy typically sets one or more related agent configuration parameters. Thus, a policy may drive the agent 150's configuration properties, settings, thresholds etc.

In a further embodiment, policy rules may encapsulate logic and need not be hard coded, but may be based on host groups or host properties and Boolean logic. The association between rules and the host groups or hosts may be dynamic, based on a rule condition and existing host group or host properties.

The following is an example of a policy:

Condition: HostGroup.tags includes ‘PLATINUM’ and HostGroup.lifecycleStage=‘PROD’

Actions: set fdLimit=5000

In this policy, if the host group tags include “PLATINUM” and the host group is marked as being in the PROD lifecycle stage, then the policy sets a configuration variable “fdLimit” to a value of “5000.” As illustrated in this example, a policy may employ multiple conditions, but the remaining examples described below are illustrated with a single condition for clarity.

The following is another example of a policy:

Condition: HostGroup.lifecycleStage=‘TEST’

Actions: set fdLimit=500

In this second policy, if the host group is marked as being in the “TEST” lifecycle stage, then the policy sets the configuration variable “fdLimit” to a value of “500.”

For computing the set of applicable agent configuration properties for a host, the policy evaluation process takes into account the host's group membership. For each group it finds the host in, the CCM policy evaluation technique follows the hierarchy of host groups and hosts going from the topmost ancestor host group down to the specific host, evaluating the policies applicable at each level. This may result in agent configuration properties being appended to, modified, or deleted at each level. The CCM 100 may then send the resulting final set of configuration properties to the agent 150 for application.

In one embodiment, the policy rules themselves may have a priority or precedence associated with them, enabling an ordering of the evaluation of all applicable policies.

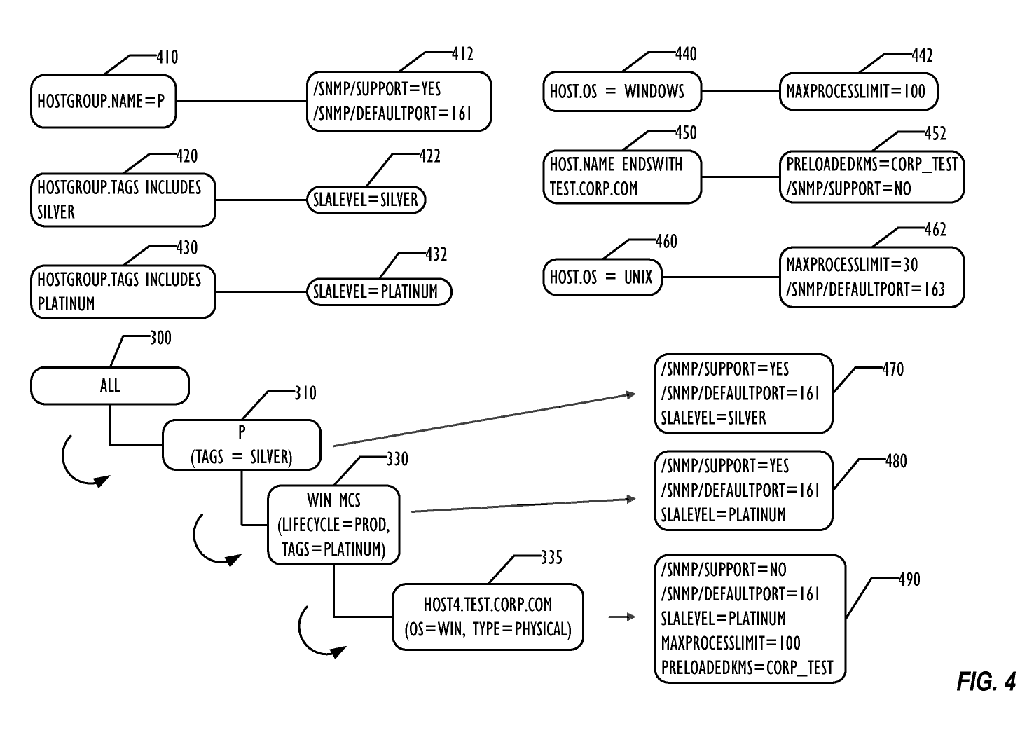

FIG. 4 is a block diagram illustrating a technique for a establishing a host group-host hierarchy according to one embodiment. In this example, 6 conditions 410, 420, 430, 440, 450, and 460 have been defined, each of which if evaluated true defines certain corresponding actions that affect properties (412, 422, 432, 442, 452, and 462, respectively). By evaluating the policies for each level of the group hierarchy between “All” group 300 and the host 335 illustrated in FIG. 3, a set of configuration properties is defined by the CCM 100 for delivery to the agent 150 on host 335, without needing to pre-configure the agent 150.

In this example, there are no policies associated with group 300. Group 310 is next considered and its associated policies evaluated. Because host group 310 is defined in the host group with the name P, condition 410 is true, and actions 412 sets properties corresponding to that condition. Because the TAGS for group 310 include the value SILVER, actions 422 are also performed, resulting in property set 470: /SNMP/SUPPORT=YES, SLALEVEL=SILVER, and /SNMP/DEFAULTPORT=161.

Moving down the hierarchy, host group 330, which indicates that LIFECYCLE=PROD, and TAGS=PLATINUM, causes the evaluation of condition 430, which updates the SLALEVEL configuration property from SILVER to PLATINUM (action 432), resulting in property set 480: /SNMP/SUPPORT=YES, /SNMP/DEFAULTPORT=161, and SLALEVEL=PLATINUM.

Moving down the hierarchy again, host 335 indicates that the OS=WIN and that it is a TYPE=PHYSICAL host, having a host name of host3.test.corp.com. Therefore, conditions 440 and 450 cause execution of actions 442 and 452. Action 342 adds the property MAXPROCESSLIMIT=100, while action 452 changes the /SNMP/SUPPORT property to NO, and adds the property PRELOADEDKMS=CORP_TEST, resulting in property set 490: /SNMP/SUPPORT=NO, /SNMP/DEFAULTPORT=161, SLALEVEL=PLATINUM, MAXPROCESSLIMIT=100, and PRELOADEDKMS=CORP_TEST. The CCM 100 may then use these configuration properties to push information to the agent 150 executing on host 335 to configure the agent 150 according to property set 490, automatically, and without human intervention. The host groups, hosts, policies, and properties described in FIG. 3 are illustrative and by way of example only. Other group hierarchies, policies, and properties may be defined as desired.

The technique described above allows properties to be defined for host groups, which may then be overridden by subsidiary host groups or by hosts themselves.

In the examples described above, the policies are hard coded, with specific values selected in each condition and action definition. In one embodiment, a policy engine allows defining policies that use variables and expressions for additional flexibility. In this embodiment, the CCM separates out the condition definition/template from the property values applicable using a property expression and lookup system. This allows separation of responsibility for maintaining the policies. For example, one administration team may define conditions and a different administration team may maintain the actions, defining property values or thresholds to be used in the rules, keeping these activities separate.

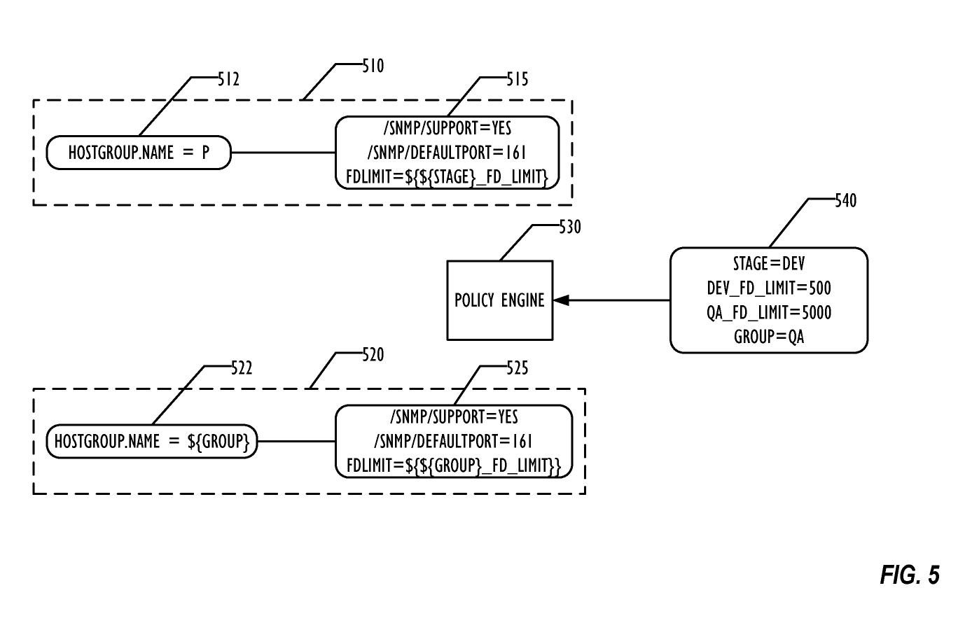

In this embodiment, illustrated by the block diagram of FIG. 5, a policy engine 530 uses data stored in a property lookup system 540 for performing condition evaluation and action execution. The property lookup system 540 may use any desired type of storage for the properties, including databases, flat files, etc., and associates variables used by the policy engine 530 with values. Expressions in the conditions and actions associated with the rules may be looked up dynamically at runtime during policy evaluation, allowing conditions that change the resulting property settings based on the evaluation of the expressions and variables. In FIG. 5, the property lookup system 540 includes at least 4 variables and their associated values: (a) a STAGE variable, with a value of DEV, (b) a DEV_FD_LIMIT variable, with a value of 500, (c) a QA_FD_LIMIT variable, with a value of 5000; and (d) a GROUP variable, with a value of QA.

When evaluating policy 510, which has a condition 512 of HOSTGROUP.NAME=P, if the condition 512 when evaluated as described above is true, then action 514 of assigning properties is taken. The policy engine 530 assigns hard coded properties /SNMP/SUPPORT=YES and /SNMP/DEFAULTPORT=161. An additional property employs variables (in this example, indicated by a prefix of “${” and a suffix of “}”). The rule evaluation engine looks up the STAGE variable in the property lookup system, and discovers that the STAGE variable has a value of “DEV.” This value is then placed into the property being evaluated by the policy engine 530, resulting in a property of “FDLIMIT=${DEV_FD_LIMIT}.” The policy engine 530 again queries the property lookup system 540, obtains the value 500 for the DEV_FD_LIMIT variable, and sets the FDLIMIT configuration element to have a value of 500.

In one embodiment, also illustrated in FIG. 5, the rule to be evaluated may contain variables, in addition to, or instead of the actions that are to be taken. In the example illustrated in FIG. 5, the rule 522 of policy 520 evaluates whether HOSTGROUP.NAME has the value “${GROUP}.” If so, then the property set 524, among other things, defines the FDLIMIT item with the value “${GROUP}_FD_LIMIT.” Thus, in this example, both rules and property actions may have variables that are looked up in the property lookup system 540 before final evaluation of the policy 520. In this example, the property lookup system 540 returns the information that the GROUP variable has the value “QA.” Therefore, the rule condition 522 becomes HOSTGROUP.NAME=QA, and if evaluated successfully, the properties /SNMP/SUPPORT=YES, /SNMP/DEFAULTPORT=161, and FDLIMIT=5000.

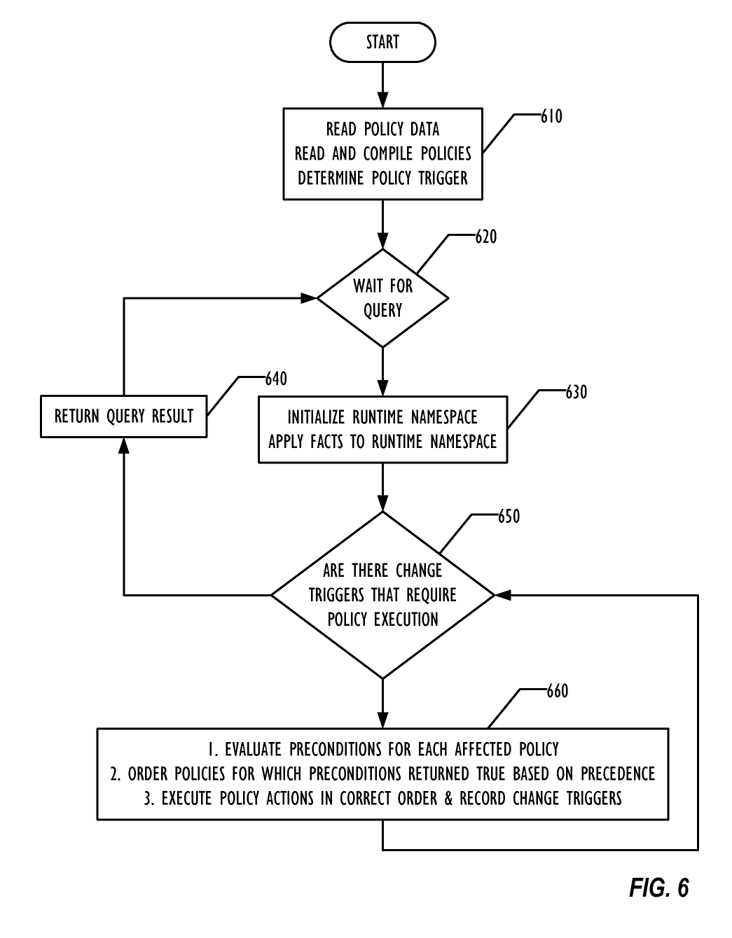

FIG. 6 is a flowchart illustrating the operation of a policy engine 530 according to one embodiment. In this embodiment, the policy engine 530 comprises a runtime namespace, at least one policy, and a policy namespace.

The runtime namespace is a namespace for building a policy resolution. For each query a new runtime namespace may be constructed. This runtime namespace is transient in nature and is empty at the start of a query and seeded with the query facts. After the query, the policy result is the filtered by the scope. A policy engine should contain at least one policy to be useful. Each policy comprises three sets of information:

Precedence: determines the order in which this policy will be evaluated, relative to the other policies for a certain “evaluation set.”

Precondition: If this condition is met, the policy action will be executed. Precondition evaluation will be triggered on changes in the runtime namespace for parameters that are included in the precondition.

Action: once the precondition is met, the action will be executed. As a result of an executing action that changes the runtime namespace, preconditions may be scheduled for evaluation. In addition to setting configuration data values as described above, the actions may be extended to execute code on the system, communicate to other systems or read files on the filesystem, if desired.

Policies may reference data stored in the policy namespace and preferably do not contain any constructs containing actual policy data.

At startup, the policy engine reads the policies and the policy data. The policies may be stored in “compiled” form for performance reasons. The policy compiler may turn a policy into the following:

Precedence: taken from the policy.

Precondition: taken from the policy.

Triggers: the list of runtime variables referenced in the precondition. If any of the precondition runtime variables are modified, the precondition should be re-evaluated

Action: taken from the policy.

Alternately, a purely interpretative policy engine may omit the policy compiler.

In block 610, the policy engine 530 reads the policy data upon startup, compiling the policies and determining policy triggers, then waits for a query in block 620. Upon receiving a query in block 630, the policy engine initializes the runtime namespace and applies any facts supplied with the query to the runtime namespace. If no triggers are changed that would cause execution of a policy action, as determined in block 650, then a query result may be returned in block 640, based on the compiled policies.

If a trigger is changed, then in block 660 each affected policy may be reevaluated. The preconditions for each affected policy are evaluated. Then, any policies where the preconditions are met may be ordered by precedence. The policy actions may then be executed in the precedence order and any changes to the triggers may be recorded. As needed, policy data may be loaded from the policy namespace.

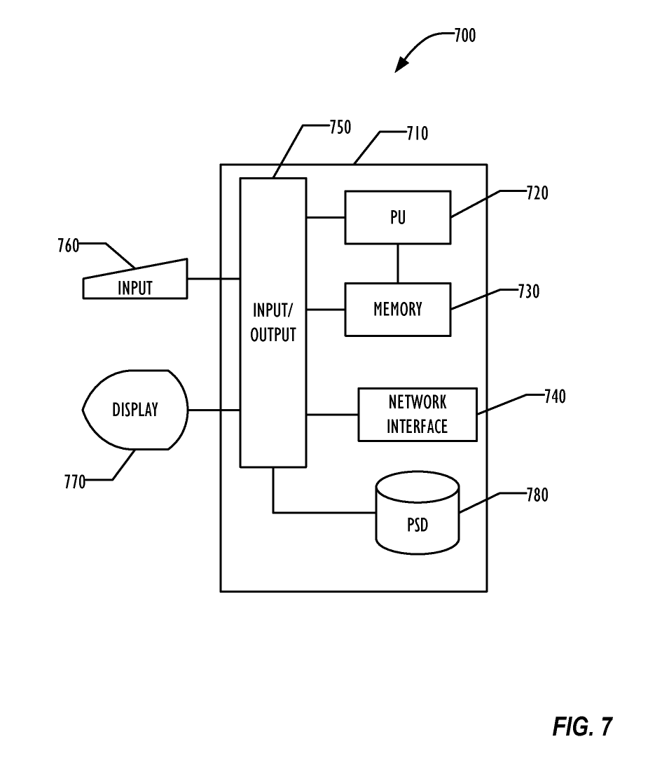

Referring now to FIG. 7, an example computer FIG. 700 for use in employing dynamic self-configuration and self-deployment of agents is illustrated in block diagram form. Example computer FIG. 700 comprises a system unit FIG. 710 which may be optionally connected to an input device or system FIG. 760 (e.g., keyboard, mouse, touch screen, etc.) and display FIG. 770. A program storage device (PSD) FIG. 780 (sometimes referred to as a hard disc) is included with the system unit FIG. 710. Also included with system unit FIG. 710 is a network interface FIG. 740 for communication via a network with other computing and corporate infrastructure devices (not shown). Network interface FIG. 740 may be included within system unit FIG. 710 or be external to system unit FIG. 710. In either case, system unit FIG. 710 will be communicatively coupled to network interface FIG. 740. Program storage device FIG. 780 represents any form of non-volatile storage including, but not limited to, all forms of optical and magnetic, including solid-state, storage elements, including removable media, and may be included within system unit FIG. 710 or be external to system unit FIG. 710. Program storage device FIG. 780 may be used for storage of software to control system unit FIG. 710, data for use by the computer FIG. 700, or both.

System unit FIG. 710 may be programmed to perform methods in accordance with this disclosure (an example of which is in FIG. 2). System unit FIG. 710 comprises a processor unit (PU) FIG. 720, input-output (I/O) interface FIG. 750 and memory FIG. 730. Processing unit FIG. 720 may include any programmable controller device including, for example, one or more members of the Intel Atom®, Core®, Pentium® and Celeron® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company.) Memory FIG. 730 may include one or more memory modules and comprise random access memory (RAM), read only memory (ROM), programmable read only memory (PROM), programmable read-write memory, and solid-state memory. One of ordinary skill in the art will also recognize that PU FIG. 720 may also include some internal memory including, for example, cache memory.

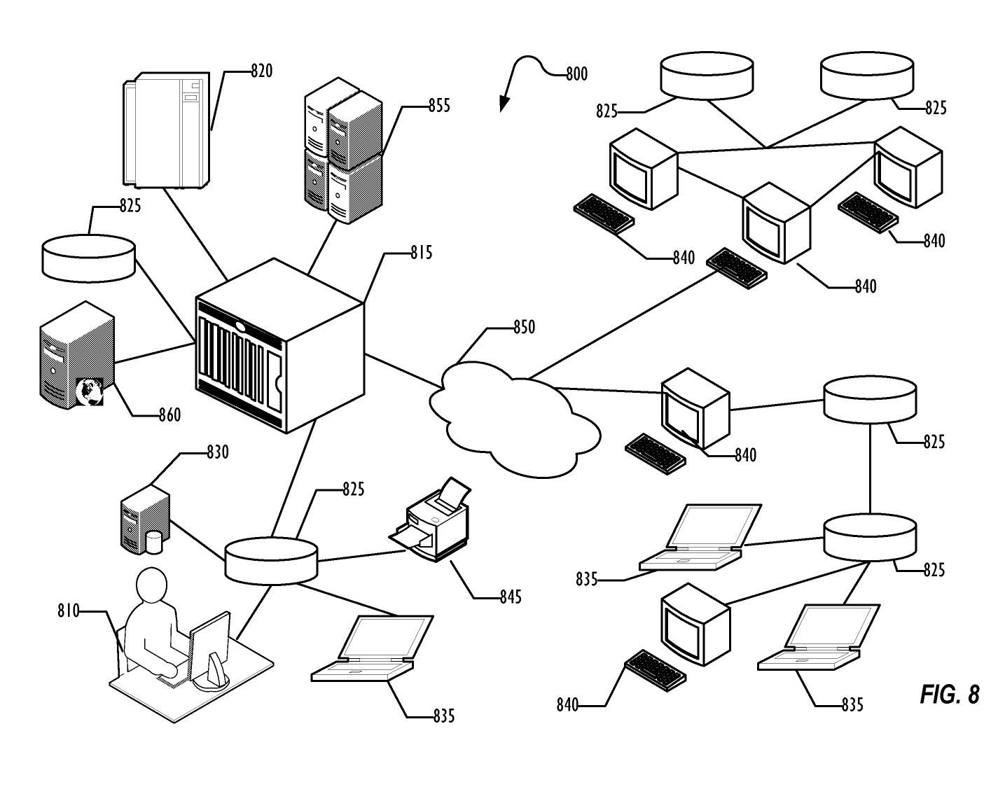

FIG. 8 is a block diagram illustrating an IT infrastructure FIG. 800 that may include elements that may be monitored by agents that incorporate the dynamic adaptive configuration technique disclosed above. A user FIG. 810 may use a terminal or workstation to access a CCM software such as illustrated in FIG. 8. The CCM 100 may execute on the workstation for the user FIG. 810 or on other computing resources of the IT infrastructure FIG. 800, such as a mainframe FIG. 820, a web server FIG. 860, a database server FIG. 830, an application server FIG. 855, and other workstations FIG. 840, laptops FIG. 835. The IT infrastructure FIG. 800 may include one or more databases FIG. 825 that store data related to the CCM corresponding to the organizational elements, services, IT hardware, and IT software that are to be monitored by the agents 150. The IT infrastructure may further include other IT resources, such as a printer FIG. 845. The IT infrastructure may be connected in any way known to the art, including using switches or routers FIG. 815 and networks FIG. 850.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method of configuring monitoring agents, comprising:
sending a generic monitoring agent to a first computer from a configuration manager executing on a second computer;
receiving information about the first computer from the generic monitoring agent;
generating automatically a customized configuration for the generic monitoring agent responsive to the information about the first computer received from the generic monitoring agent; and
sending the customized configuration to the generic monitoring agent.

2. The method of claim 1, wherein the act of receiving information about the first computer from the generic monitoring agent comprises:
receiving a first set of information about the first computer from the generic monitoring agent by the configuration manager;
sending a manageability probe to the generic monitoring agent from the configuration manager, wherein the manageability probe is configured responsive to the first set of information to discover information about the first computer when executed by the generic monitoring agent; and
receiving by the configuration manager a second set of information discovered by the manageability probe about the first computer.

3. The method of claim 1, further comprising:
receiving an updated information about the first computer by the configuration manager; and
repeating the act of generating automatically a customized configuration for the generic monitoring agent and the act of sending the customized configuration to the generic monitoring agent, responsive to performing the act of receiving an updated information about the first computer.

4. The method of claim 3, wherein the customized configuration for the generic monitoring agent is updated to configure the generic monitoring agent to monitor an additional resource on the first computer.

5. The method of claim 3, wherein the customized configuration for the generic monitoring agent is updated to configure the generic monitoring agent to stop monitoring a resource on the first computer.

6. The method of claim 1, wherein the act of sending a generic monitoring agent to a first computer from a configuration manager executing on a second computer comprises:
sending a generic monitoring agent to the first computer configured with a credentials for the configuration manager and a location of the configuration manager.

7. The method of claim 1, wherein act of receiving information about the first computer from the generic monitoring agent comprises:
receiving an identification of the first computer;
receiving information corresponding to an operating system executing on the first computer; and
receiving a network address of the generic monitoring agent.

8. The method of claim 1, wherein the act of receiving information about the first computer from the generic monitoring agent comprises:
receiving information corresponding to software applications installed on the first computer.

9. The method of claim 1, wherein the act of sending the customized configuration to the generic monitoring agent comprises:
sending an executable management module configured to monitor a resource available on the first computer identified by the information about the first computer received from the generic monitoring agent.

10. The method of claim 1, wherein the act of generating automatically a customized configuration for the generic monitoring agent responsive to the information about the first computer received from the generic monitoring agent comprises:
evaluating a first policy, wherein the first policy defines a first condition and a first action to be taken if the first condition is true.

11. The method of claim 10, wherein the act of evaluating a first policy comprises:
evaluating the first policy by a policy engine.

12. The method of claim 10, wherein the act of evaluating a first policy comprises:
selecting the policy responsive to membership of the first computer in a group of computers.

13. The method of claim 10, wherein the act of generating automatically a customized configuration for the generic monitoring agent responsive to the information about the first computer received from the generic monitoring agent further comprises:
evaluating a second policy, wherein the second policy defines a second condition and a second action to be taken if the first condition is true,
wherein the act of evaluating a first policy and the act of evaluating a second policy are performed according to a precedence relationship between the first policy and the second policy.

14. The method of claim 10, wherein the act of evaluating a first policy comprises:
evaluating a policy expression at runtime, modifying the first action responsive to the evaluation of the policy expression.

15. A computer readable medium with instructions for a programmable control device stored thereon wherein the instructions cause a programmable control device to perform the method of claim 1.

16. A system comprising:
a first computer;
a generic monitoring agent, executable on the first computer;
a second computer;
a processor;
a storage device, coupled to the processor; and
a configuration manager, stored on the storage device and executable on the second computer, configured to:
receive a first information about the first computer from the generic monitoring agent; and
send a customized configuration for the generic monitoring agent to the generic monitoring agent, responsive to the first information.

17. The system of claim 16, further comprising:
a policy database, stored on the storage device, comprising a set of policies, each of which comprises:
a condition; and
an action to be taken if the condition is true,
wherein the set of policies is used to generate the customized configuration for the generic monitoring agent by the configuration manager, responsive to the first information about the first computer.

18. The system of claim 17, wherein the action to be taken if the condition is true comprises an expression evaluated at runtime.

19. The system of claim 17, further comprising:
a policy engine, configured to evaluate policies stored in the policy database as requested by the configuration manager.

20. The system of claim 16, further comprising:
a manageability probe, sent by the configuration manager to the generic monitoring agent and executable by the generic monitoring agent,
wherein the manageability probe discovers the first information about the first computer.
